(19) United States
(12) Patent Application Publication
(10) Pub. No.: US 2012/0329564 A1
(43) Pub. Date: Dec. 27, 2012

(54) TRIPOD CONSTANT VELOCITY UNIVERSAL JOINT

(76) Inventors: Taku Itagaki, Iwata-shi (JP); Tatsuro Sugiyama, Iwata-shi (JP); Masayuki Kuroda, Takarazuka-shi (JP)

(21) Appl. No.: 13/634,371

(22) PCT Filed: Mar. 19, 2010
(86) PCT No.: PCT/JP2010/054783

§ 371 Date: Sep. 12, 2012

(51) Int. Cl. F16D 3/24

(52) U.S. Cl. 464/111

(57) ABSTRACT

A tripod constant velocity universal joint is configured with only three parts including an outer ring (10), a tripod (20), and spherical rollers (30). Trunnions (26) are allowed to make direct contact with the spherical rollers (30). The outer ring (10) includes three track grooves (14) parallel to its axis in the inner circumference thereof. Roller guide surfaces (16) are formed on both side walls of the respective track grooves (14). The tripod (20) is inserted inside the outer ring (10) and composed of a boss (22) and three trunnions (26) protruding radially from the boss (22). The spherical rollers (30) are rotatably supported on the trunnions (26), and can move in the axial direction of the outer ring (10) as they roll in the track grooves (14) of the outer ring (10) along the roller guide surfaces (16).

### TECHNICAL FIELD

This invention relates to a tripod constant velocity universal joint, which is applicable to power transmission devices of automobiles and various industrial machines and the like.

### BACKGROUND ART

Generally, a constant velocity universal joint has an outer joint member and an inner joint member respectively connected to one or the other of a drive shaft and a driven shaft, and a torque transmitting member interposed therebetween, to be able to transmit torque between the angled drive shaft and driven shaft. Joints are roughly classified into a fixed type capable of changing only the angle, and a sliding type capable not only of changing the angle but also of displacing in the axial direction (plunging). The tripod constant velocity universal joint is a sliding type. The joint has, as its primary constituent elements, an outer ring 110 as an outer joint member, a tripod 120 as an inner joint member, and spherical rollers 130 as a torque transmitting member, as shown in FIG. 4.

The outer ring 110 is composed of a mouth part 112 and a stem part (not shown), and connected to a drive shaft or a driven shaft at an externally splined (orserrated, hereinafter ditto where applicable) portion of the stem part such as to be able to transmit torque. The mouth part 112 is cup-shaped, and includes three axially extending, and circumferentially equally spaced, track grooves 114 in the inner circumference thereof. Roller guide surfaces 116 are formed on opposing side walls of the track grooves 114.

The tripod 120 is composed of a boss 122 and three trunnions 126. An internally splined hole 124 is provided in the boss 122 for connection with a driven shaft or a drive shaft such as to be able to transmit torque. The three trunnions 126 are equally spaced in the circumferential direction of the boss 122, each protruding radially from the boss 122. The trunnions 126 are each cylindrical and formed with an annular groove 128 near their distal ends.

The spherical rollers 130 are attached on the respective trunnions 126. A plurality of (full complement of) needle rollers 132 are interposed between the spherical rollers 130 and the trunnions 126. Thus the spherical rollers 130 are rotatable relative to the trunnions 126. Inner washers 134 and outer washers 136 are disposed at both axial ends of the needle rollers 132. The inner washers 134 sit on the shoulders at the base of the trunnions 126. Circlips 138 are fitted in the annular grooves 128 of the trunnions 126 to restrict movement of the outer washers 136 toward the distal ends of the trunnions 126. Thus the needle rollers 132 are restricted from moving toward the distal ends of the trunnions 126 (retained).

### CITATION LIST

### Patent Literature

Patent Literature 1: Japanese Patent No. 3615987

### SUMMARY OF INVENTION

### Technical Problem

Conventional tripod constant velocity universal joints require many components other than the outer ring 110 and the tripod 120, such as the spherical rollers 130, needle rollers 132, inner washers 134, outer washers 136, and circlips 138. The large number of components is an issue to be resolved in terms of cost etc.

Accordingly, an object of this invention is to reduce the number of components of tripod constant velocity universal joints.

### Solution to Problem

This invention solves the problem by using spherical rollers only as a torque transmitting member, and establishing direct contact between an outer circumferential surface of trunnions and an inner circumferential surface of the spherical rollers. Namely, the tripod constant velocity universal joint of this invention includes an outer ring having three axially extending track grooves formed in the inner circumference and roller guide surfaces formed on both side walls of the respective track grooves, a tripod composed of a boss and three trunnions radially protruding from this boss, and spherical rollers supported rotatably and axially movably relative to the respective trunnions and inserted in the track grooves. The joint is characterized in that the trunnions are allowed to make direct contact with the spherical rollers, and cavities are formed between the trunnions and the spherical rollers in the axial direction of the boss of the tripod. Thereby, the tripod constant velocity universal joint is configured with only three components, the outer ring (outer joint member), the tripod (inner joint member), and the spherical rollers (torque transmitting member), so that the number of components is largely reduced.

In a structure in which spherical rollers having a cylindrical inner circumferential surface are fitted on trunnions having a cylindrical outer circumferential surface with a desired clearance therebetween, the contact area between the outer circumferential surface of the trunnions and the inner circumferential surface of the spherical rollers is large and therefore the friction resistance against relative rotation of the trunnions and spherical rollers is high. Only a minimum necessary clearance for fitting the spherical rollers on the trunnions does not provide good interposition of grease between the outer circumferential surface of the trunnions and the inner circumferential surface of the spherical rollers. There is thus a possibility that smooth rolling of the spherical rollers may be inhibited. Cavities, therefore, are provided between the outer circumferential surface of the trunnions and the inner circumferential surface of the spherical rollers in the axial direction of the boss of the tripod. With such a configuration, grease can stay in the cavities to promote rolling of the spherical rollers.

Cavities can be provided between the trunnions and spherical rollers by, for example, removing the cylindrical outer circumferential surface of the trunnions over a predetermined region containing the portion located along the axial direction of the boss.

The spherical rollers should preferably have an outer circumferential shape in a longitudinal cross section that is a circular arc having a center of curvature on the rotation axis of the spherical rollers. In this case, the outer circumferential surface of the spherical rollers is part-spherical, so that the rollers can roll easily on the roller guide surfaces.

The trunnions may have a perfect circular cross-sectional shape, i.e., the cross-sectional shape of the trunnions may be part of a perfect circle at least in a portion other than the removed portion, i.e., the portion being in contact with the inner circumferential surface of the spherical rollers. Alternatively, the trunnions may have a non-perfect circular cross-sectional shape at least in a portion being in contact with an inner circumferential surface of the spherical rollers. Examples of non-perfect circular shapes include circular arcs having centers at positions away from the axes of the trunnions, or ellipse. In the case with ellipse, outer circumferential surfaces on opposite sides of the major axis of ellipse of the trunnion will be in contact with the inner circumferential surface of the spherical roller.

By forming the trunnions to have a non-perfect circular cross-sectional shape, there are created gaps between the trunnions and spherical rollers that increase from the contact points therebetween gradually toward the cavities, so that grease is drawn in readily, as well as the contact width between the trunnions and spherical rollers is reduced, as a result of which the spherical rollers can rock easily. This promotes rolling of the spherical rollers, so that the constant velocity universal joint produces less vibration.

At least portions of the trunnions being in contact with the inner circumferential surface of the spherical rollers should preferably be finished by grinding or hardened steel machining. A process known as dry cutting, of hardened steel machining, is more advantageous in environmental terms, as it does not use grinding lubricant (coolant) necessary for the grinding.

The trunnions should preferably be provided with a hardened layer formed by a surface heat treatment process. The trunnions require high strength and durability as they are in contact with the spherical rollers and transmit torque. Various surface-hardening processes are known, such as, for example, carburizing quenching, carbonitriding, and high frequency quenching, any of which may be selected.

The hardened layer may be provided at least at the base and on the outer circumference of the trunnions if it is formed by high frequency quenching. High frequency quenching is advantageous in that necessary parts can be locally quenched.

### Advantageous Effects of Invention

According to this invention, constituent components of a tripod constant velocity universal joint are reduced to three, an outer ring, a tripod, and spherical rollers, i.e., the number of components for a tripod constant velocity universal joint is largely reduced. Cavities are provided between trunnions and spherical rollers in the axial direction of the boss of the tripod to allow the grease to stay better to promote rolling of the spherical rollers. Thus the spherical rollers can roll smoothly along the roller guide surfaces during plunging of the tripod constant velocity universal joint, which contributes to lower slide resistance and induced thrust.

### BRIEF DESCRIPTION OF DRAWINGS

FIG. 1 is a cross-sectional view of a tripod constant velocity universal joint, illustrating one embodiment of this invention.

FIG. 2 is a longitudinal sectional view of the tripod constant velocity universal joint of FIG. 1 at an operating angle.

FIG. 3A is a diagram corresponding to a III-III cross section of FIG. 1, illustrating a trunnion having a perfect circular cross-sectional shape.

FIG. 3B is a diagram corresponding to a III-III cross section of FIG. 1, illustrating a trunnion having a non-perfect circular cross-sectional shape.

FIG. 3C is an elliptical cross-sectional view of the trunnion.

FIG. 4 is a cross-sectional view of a conventional tripod constant velocity universal joint.

### DESCRIPTION OF EMBODIMENTS

Embodiments of this invention will be hereinafter described with reference to the drawings.

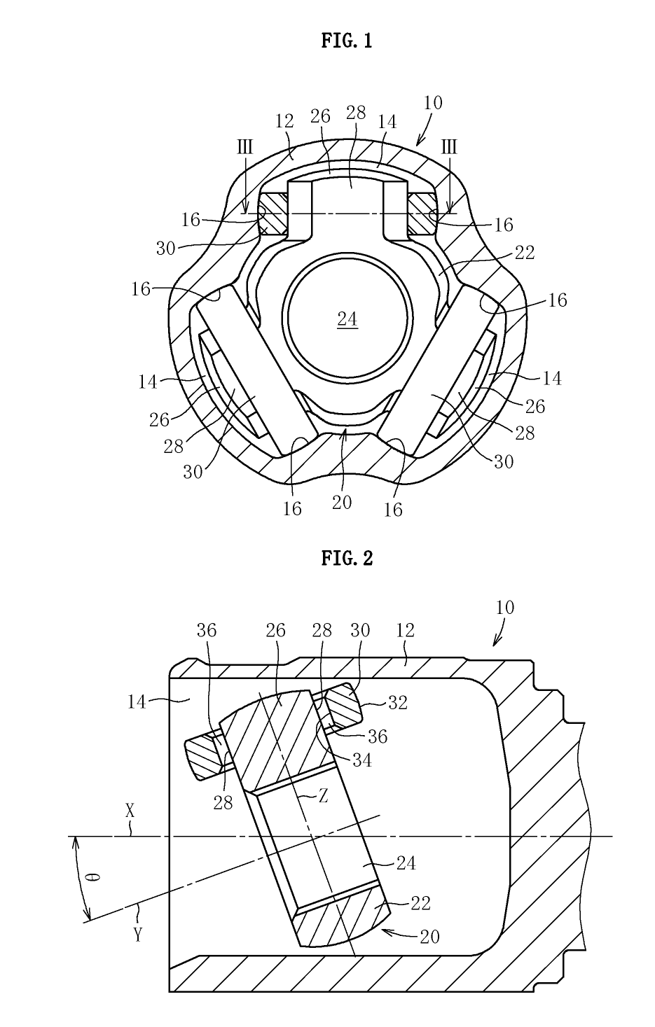

The tripod constant velocity universal joint shown in FIG. 1 and FIG. 2 is configured with three parts including an outer ring 10 that serves as an outer joint member, a tripod 20 that serves as an inner joint member, and spherical rollers 30 that serve as a torque transmitting member. As is clear from FIG. 1, this tripod constant velocity universal joint is configured with only three parts, the outer ring 10, tripod 20, and spherical rollers 30. The total number of the spherical rollers 30 is, obviously, three.

The outer ring 10 is composed of a mouth part 12 and a stem part (not shown), and connected to a drive shaft or a driven shaft at an externally splined portion of the stem part such as to be able to transmit torque. The mouth part 12 is cup-shaped, and includes three track grooves 14 in the inner circumference thereof. The track grooves 14 are equally spaced in the circumferential direction of the mouth part 12 and extend parallel to the axis X of the mouth part 12. Roller guide surfaces 16 are formed on opposing side walls of the respective track grooves 14. The roller guide surfaces 16 are part of a cylindrical surface, their cross section orthogonal to the axis X being part of a perfect circle.

The tripod 20 is composed of a boss 22 and three trunnions 26. An internally splined hole 24 is provided in the boss 22 for connection with a driven shaft or a drive shaft such as to be able to transmit torque. The three trunnions 26 are equally spaced in the circumferential direction of the boss 22, each protruding radially from the boss 22. A spherical roller 30 is attached to each trunnion 26 such that the trunnion 26 and the spherical roller 30 are brought in direct contact with each other. The spherical rollers 30 are accommodated in the track grooves 14, with their outer circumferential surfaces 32 making direct contact with the roller guide surfaces 16.

Each spherical roller 30 is ring-like and has a part-spherical outer circumferential surface 32 and a cylindrical inner circumferential surface 34. Because of the need in this mechanism for the spherical roller 30 to incline when the joint is at an operating angle of θ (see FIG. 2), the outer circumferential surface 32 of the spherical roller 30 is part-spherical, i.e., it is part of a spherical surface having a center of curvature on the rotation axis of the spherical roller 30. In other words, the outer circumferential surface 32 in a longitudinal cross section of the spherical roller 30 has a circular arc shape having a center of curvature on the rotation axis of the spherical roller 30. The radius of curvature of the outer circumferential surface 32 of the spherical roller 30 is substantially the same as the radius of curvature of the roller guide surface 16, or, the radius of curvature of the roller guide surface 16 may be larger. The circular arc shape of the outer circumferential surface 32 in a longitudinal cross section of the spherical roller 30 may have a center of curvature away from the rotation axis of the spherical roller 30. In this case, the outer circumferential surface 32 of the spherical roller 30 is part of a torus (ring torus).

As can be seen from FIG. 2, each trunnion 26 has planar portions 28 orthogonal to the axis Y of the boss 22. The planar portions 28 are recessed from an imaginary cylindrical surface of the trunnion 26 toward the axis thereof. Cavities 36 are formed between the planar portions 28 of the trunnion 26 and the inner circumferential surface 34 of the spherical roller 30 in the direction of the axis Y of the boss 22. Since the planar portions 28 are flat surfaces here, the cavities 36 have a crescent cross-sectional shape. Provision of such cavities 36 is expected to allow the lubricant (grease) to stay better between the trunnions 26 and the spherical rollers 30 and to promote rolling of the spherical rollers 30.

While the planar portions 28 are flat in the illustrated embodiment, they need not necessarily be flat. They may be formed as other than flat surfaces, such as convex or concave curved surfaces, as long as cavities 36 can be formed as desired between themselves and the inner circumferential surfaces of the spherical rollers 30. While the planar portions 28 extend over the entire length of the trunnions 26 and are flush with the end face of the boss 22 in the illustrated embodiment, they need not necessarily be flush with the end face of the boss 22. It is, however, advantageous in production aspects if the planar portions 28 are flat and flush with the end face of the boss 22 because they can then be processed relatively easily. Typically, the entire body of the tripod 20 is formed by forging, after which the splined hole 24 and the outer circumferential surface of the trunnions 26 are finished by machining. The planar portions 28 may be formed simultaneously in the process of forging, or, they may be formed by cutting, after forging the body in a cylindrical shape.

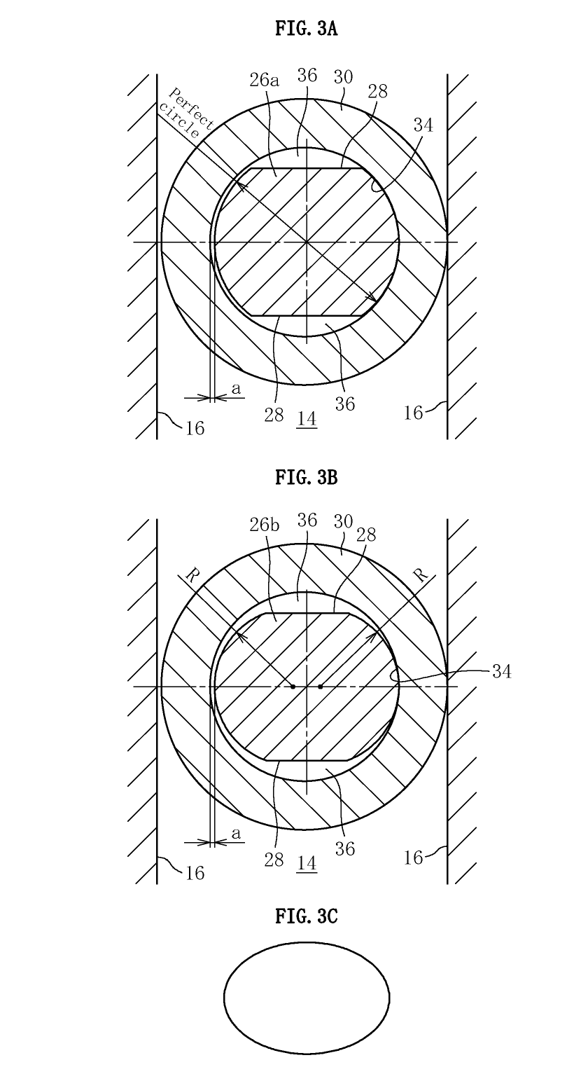

Referring to FIG. 3A, the trunnion is specifically denoted by reference numeral 26a. The trunnion 26a has a perfect circular cross sectional shape in a section orthogonal to the axis Z (FIG. 2) of the trunnion 26a, i.e., the shape is part of a perfect circle, at least in a region where the trunnion is in contact with the inner circumferential surface 34 of the spherical roller 30. This perfect circle has its center on the axis Z of the trunnion 26a.

Referring to FIG. 3B, the trunnion is specifically denoted by reference numeral 26b. The cross-sectional shape of the trunnion 26b may be non-perfect circular, at least in a region where the trunnion is in contact with the inner circumferential surface 34 of the spherical roller 30. FIG. 3B shows an example where the outer circumferential surface of the trunnion 26b has a circular arc cross-sectional shape having a center of curvature away from the axis Z of the trunnion 26b. In other words, it is an example where the circular arc does not have the center of curvature on the axis Z of the trunnion 26b. The radius of curvature of the circular arc is represented by reference symbol R.

In the case with FIG. 3B, the spherical roller 30 can rock more easily about a point of application of a load, as compared to the case where the trunnion 26b has a perfect circular cross-sectional shape as noted above. In FIG. 3A and FIG. 3B, the one dot chain line orthogonal to the roller guide surfaces 16 indicate the direction in which a torque load is applied. The intersections between this one dot chain line and the roller guide surfaces 16 are the points of application of a load. As can be seen from FIG. 3A and FIG. 3B, since there is a slight gap (a) on the counter load side, the drawings show that the force is acting from the right side to the left side when torque is transmitted from the outer ring 10.

Ellipse is another example of a non-perfect circular cross-sectional shape of the trunnions 26. In this case, the trunnions would have an oval cross-sectional shape similar to the one shown in FIG. 3B, and accordingly the same advantageous effects by the configuration of FIG. 3B described in relation to the rocking of the spherical rollers 30 can be expected.

Consequently, it is expected that this tripod constant velocity universal joint, if mounted on a vehicle, for example, will have an effect of absorbing and reducing vibration transmitted from the engine to the drive shaft during stop (during idling) and occurring in the axial direction of the joint (reduction of slide resistance). It is also expected that the force generated in the axial direction of the joint (induced thrust) is reduced, as the spherical rollers 30 can roll more easily by their rocking motion when the joint rotates at an operating angle.

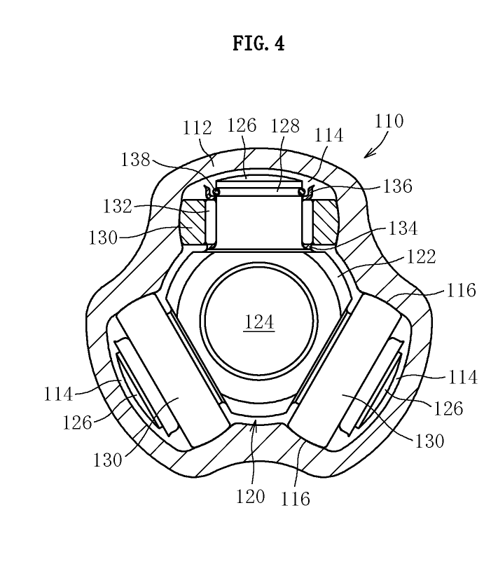

A conventional tripod constant velocity universal joint typically has a structure in which spherical rollers are mounted to the outer circumference of trunnions via a plurality of needle rollers, as shown in FIG. 4. One problem in this structure is that, when torque is transmitted between the outer ring and the tripod at a certain operating angle, the respective spherical rollers and roller guide surfaces intersect each other diagonally as the trunnions are inclined, and slippage occurring therebetween obstructs smooth rolling of the spherical rollers, whereby induced thrust is increased. Another problem is that slide resistance when the outer ring and the tripod displace in the axial direction relative to each other is increased by the friction between the respective spherical rollers and roller guide surfaces.

Here, “induced thrust” refers to a force in the axial direction of a constant velocity universal joint generated by friction inside the joint when torque is applied at a certain angle during rotation of the joint. Induced thrust is primarily generated as a third force component and can be large in tripod joints. “Slide resistance” refers to an amount of friction generated in the axial direction when the outer ring and the tripod slide on each other in a sliding type joint such as the tripod constant velocity universal joint. Induced thrust and slide resistance are causes of vehicle body vibration and noise. Since induced thrust and slide resistance affect the NVH characteristics of an automobile and lead to a lower degree of freedom of design for the wheel support structure of the vehicle, they are desired to be as low as possible. NVH stands for noise, vibration, and harshness; it is a terminology used for evaluating how much noise and vibration of a vehicle are reduced.

In other words, in this type of tripod constant velocity universal joint, when torque is transmitted at a certain angle, induced thrust is generated by friction between internal components during rotation, and, during stop, slide resistance is generated when the joint is forcedly extended and contracted in the axial direction. Typical NVH phenomena in automobiles associated with the induced thrust and slide resistance include rolling of the vehicle body during driving caused by the former, and idling vibration in D range of a stopped AT vehicle caused by the latter.

How much the induced thrust and slide resistance in the joint are reduced is the key point in resolving the NVH issues of an automobile. Generally, the induced thrust and slide resistance in the joint tend to be dependent on the degree of operating angle. Applying the joint to an automobile drive shaft therefore leads to a design restriction that the operating angle cannot be made large. Accordingly, it was a requirement to keep the induced thrust and slide resistance low so as to increase the degree of freedom of design for the wheel support structure of an automobile.

The trunnions 26 are subjected to a surface-hardening process to provide a hardened layer. Various surface-hardening processes are known including, for example, carburizing quenching, carbonitriding, and high frequency quenching, any of which may be selected. With high frequency quenching, it is suffice to provide a hardened layer at least at the base and on the outer circumferential surface of the trunnions 26.

Carburizing quenching is a process used to form hard martensite on the surface over the inner tough martensite using low carbon steels or steel alloys. In this process, carbon is infused into the steel surface typically at a temperature of from 900 to 930° C. to increase the carbon content only in the surface to about 0.8% and the steel is quenched, after which it is tempered at a lower temperature of about, for example, 180° C. Carburizing includes solid carburizing, liquid carburizing, and gas carburizing.

Carbonitriding is a process used to surface-harden steel by diffusing carbon and nitrogen at the same time into the steel surface, and by subsequent quenching. Carbonitriding includes gas carbonitriding performed in a carburizing carrier gas with HNO₃ added thereto, and liquid nitriding (carburizing) performed in a bath of salt such as sodium cyanide. As carbon infuses better at higher temperatures and nitrogen infuses better at lower temperatures, the process is performed at a temperature of from 800 to 900° C.

High frequency quenching is a process used to surface-harden middle carbon steels having a carbon content of generally 0.3 to 0.5%. In this process, the steel is preliminarily quenched and tempered to have sufficient strength and toughness over the entire cross section, after which it is rapidly heated by induction heating using high frequency electric current to form an austenitic surface layer before being quenched. Designing a specific shape for the coil used for the high frequency heating enables local heating of necessary parts alone.

Further, at least portions of the trunnions 26 being in contact with the inner circumferential surface 34 of the spherical rollers 30 are finished by grinding or hardened steel machining. Hardened steel machining is a process used to machine a hardened workpiece using a high hardness tool such as a CBN (cubic boron nitride) sintered tool. A process known as dry cutting, of hardened steel machining, is more advantageous in environmental terms, as it does not use grinding lubricant (coolant) necessary for the grinding.

### REFERENCE SIGNS LIST

10 outer ring (outer joint member)

12 mouth part

14 track groove

16 roller guide surface

20 tripod (inner joint member)

22 boss

24 spline hole

26, 26a, 26b trunnion

28 planar portion

30 spherical roller (torque transmitting member)

32 outer circumferential surface

34 inner circumferential surface

36 cavity

1. A tripod constant velocity universal joint, comprising: an outer ring having three track grooves formed in an inner circumference thereof parallel to an axis thereof and roller guide surfaces formed on both side walls of the respective track grooves; a tripod composed of a boss and three trunnions radially protruding from the boss; and spherical rollers supported rotatably and axially movably relative to the respective trunnions and inserted in the track grooves,
wherein an inner peripheral surface of the spherical roller is cylindrical,
wherein each of the trunnions has a planar portion recessed from an imaginary cylindrical surface of and toward the axis of the trunnions, and
wherein the trunnions are allowed to make direct contact with the spherical rollers, and cavities are formed between the trunnions and the spherical rollers in an axial direction of the boss of the tripod.

2. The tripod constant velocity universal joint according to claim 1, wherein the trunnions have a perfect circular cross-sectional shape at least in a portion being in contact with an inner circumferential surface of the spherical rollers.

3. The tripod constant velocity universal joint according to claim 1, wherein the trunnions have a non-perfect circular cross-sectional shape at least in a portion being in contact with an inner circumferential surface of the spherical rollers.

4. The tripod constant velocity universal joint according to claim 3, wherein the non-perfect circular shape is ellipse.

5. The tripod constant velocity universal joint according to claim 3, wherein the non-perfect circular shape is a circular arc having a center of curvature at a position away from an axis of a trunnion.

6. The tripod constant velocity universal joint according to claim 1, wherein the spherical rollers have a longitudinal cross-sectional outer circumferential shape that is a circular arc having a center of curvature on an axis of a spherical roller.

7. The tripod constant velocity universal joint according to claim 1, wherein at least a portion of the trunnions being in contact with an inner circumferential surface of the spherical rollers is finished by grinding or hardened steel machining

8. The tripod constant velocity universal joint according to claim 1, wherein the trunnions have a hardened layer formed by a surface heat treatment process.

9. The tripod constant velocity universal joint according to claim 8, wherein the trunnions have a hardened layer formed by high frequency quenching at least at a base and on an outer circumferential surface thereof.

10. The tripod constant velocity universal joint according to claim 2, wherein the spherical rollers have a longitudinal cross-sectional outer circumferential shape that is a circular arc having a center of curvature on an axis of a spherical roller.

11. The tripod constant velocity universal joint according to claim 3, wherein the spherical rollers have a longitudinal cross-sectional outer circumferential shape that is a circular arc having a center of curvature on an axis of a spherical roller.

12. The tripod constant velocity universal joint according to claim 4, wherein the spherical rollers have a longitudinal cross-sectional outer circumferential shape that is a circular arc having a center of curvature on an axis of a spherical roller.

13. The tripod constant velocity universal joint according to claim 5, wherein the spherical rollers have a longitudinal cross-sectional outer circumferential shape that is a circular arc having a center of curvature on an axis of a spherical roller.

14. The tripod constant velocity universal joint according to claim 2, wherein at least a portion of the trunnions being in contact with an inner circumferential surface of the spherical rollers is finished by grinding or hardened steel machining

15. The tripod constant velocity universal joint according to claim 3, wherein at least a portion of the trunnions being in contact with an inner circumferential surface of the spherical rollers is finished by grinding or hardened steel machining

16. The tripod constant velocity universal joint according to claim 4, wherein at least a portion of the trunnions being in contact with an inner circumferential surface of the spherical rollers is finished by grinding or hardened steel machining

17. The tripod constant velocity universal joint according to claim 5, wherein at least a portion of the trunnions being in contact with an inner circumferential surface of the spherical rollers is finished by grinding or hardened steel machining

18. The tripod constant velocity universal joint according to claim 6, wherein at least a portion of the trunnions being in contact with an inner circumferential surface of the spherical rollers is finished by grinding or hardened steel machining

19. The tripod constant velocity universal joint according to claim 10, wherein at least a portion of the trunnions being in contact with an inner circumferential surface of the spherical rollers is finished by grinding or hardened steel machining

20. The tripod constant velocity universal joint according to claim 11, wherein at least a portion of the trunnions being in contact with an inner circumferential surface of the spherical rollers is finished by grinding or hardened steel machining
